(19) United States
(12) Patent Application Publication
(10) Pub. No.: US 2011/0290042 A1
(43) Pub. Date: Dec. 1, 2011

(54) Liquid Sample Injection Device and Liquid Sample Injection Method

(75) Inventor: Yoshiaki MAEDA, Kyoto-shi (JP)

(73) Assignee: SHIMADZU CORPORATION, Kyoto-shi (JP)

(21) Appl. No.: 13/110,781

(22) Filed: May 18, 2011

(30) Foreign Application Priority Data
May 31, 2010 (JP) 2010-124884

(51) Int. Cl. G01N 35/10

(52) U.S. Cl. 73/864.21

(57) ABSTRACT

The present invention provides a liquid sample injection device and liquid sample injection method using a total volume injection method, which can prevent clogging of the channel or the needle, or carry-over of analysis components. The present invention is characterized by: moving the tip of a needle 9, before collecting a liquid sample, to an area where a predetermined fluid (for example, air, water, or the like) which reacts with neither the liquid sample nor the mobile phase is present; sucking the given fluid from the tip; and inserting the tip into a vial 15 to suck a predetermined amount of the liquid sample in the vial 15. As a result, a layer of the predetermined fluid is formed between the mobile phase remaining in the needle 9 and the newly sucked liquid sample. Thus, the mobile phase and the liquid sample are prevented from being in contact with each other in the needle 9. Accordingly, a precipitate due to reaction between the solvent of the liquid sample and the mobile phase can be avoided, and clogging of the channel with a precipitate or carry-over is prevented.

### TECHNICAL FIELD

The present invention relates to a liquid sample injection device and a method for injecting a liquid sample for collecting a predetermined amount of a liquid sample and injecting the entire amount of the collected liquid sample into a mobile phase flowing through a channel,

### BACKGROUND ART

Liquid chromatographic analysis uses a liquid sample injection device (auto-sampler) for automatically sending a plurality of liquid samples sequentially to a column. Liquid sample injection devices of this kind mainly employ two types of injection methods. One is a partial volume injection method in which a portion of a liquid sample collected from a sample bottle is injected into a mobile phase. The other is a total volume injection method in which the entire amount of a liquid sample collected from a sample bottle is injected into a mobile phase.

A partial volume injection method proceeds as follows: a liquid sample is collected with a needle; the liquid sample is introduced into a sample loop through a sample injection port; and the liquid sample held in the sample loop of a predetermined volume is sent to the column by a flow of the mobile phase. In collecting the liquid sample with the needle, the liquid sample contacts a cleaning liquid which have been previously filled in the needle so that the liquid sample may be partly diluted. In the partial volume injection method, the local alteration of the concentration of the liquid sample in the needle leads to a variation in the results of a quantitative analysis depending on which portion of the liquid sample is sent to the column.

A total volume injection method proceeds as follows: a predetermined amount of liquid sample is collected from a tip of a needle using a measuring pump; the tip of the needle is connected to a sample injection port; a mobile phase is fed into the needle from the back of the needle; and the entire amount of the collected liquid sample is sent to the column. In this system, after an analysis of one liquid sample is completed and before the next liquid sample is sucked, the mobile phase sucked in the needle in the previous analysis remains in the needle, and the needle is filled with the mobile phase to the tip thereof. In the case of conventional devices, the needle in such a state is inserted into a sample bottle to newly suck the liquid sample. Due to this operation, the sucked liquid sample contacts the mobile phase in the needle. As a result, a portion of the sample diffuses in the mobile phase at the interface therebetween. The diffusion decreases the concentration of the sample near the interface. However, in the total volume injection method, since the entire amount of the collected liquid sample is sent to the column, partial decrease in the sample concentration in the needle does not cause any variation in the result of a quantitative analysis.

### Background Art Document

### Patent Document

Patent Document 1: WO 2009/041441

Patent Document 2: WO 2009/041442

### DISCLOSURE OF THE INVENTION

### Problem to be Solved by the Invention

In a liquid chromatographic analysis, a liquid sample is generally prepared by dissolving a substance to be analyzed in a solvent. As the solvent, various kinds of solvents may be used, such as an organic solvent, water, and a mixture of an organic solvent and water depending on the substance to be analyzed, analysis conditions, and other factors. For some samples, reproducibility of the component separation in the column is hampered due to a slight change in the pH. For such samples, a buffer solution may be used to keep the pH constant. Moreover, similarly to the solvent, various kinds of mobile phases may be used depending on the nature of the liquid sample, analysis conditions, and other factors. Therefore, a wide range of combinations are available for the solvent and the mobile phase for the liquid sample.

In conventional liquid sample injection devices using a total volume injection method, the liquid sample contacts the mobile phase in the needle. Therefore, depending on the combination of the solvent of the liquid sample and the mobile phase, they may react with one another, resulting in a precipitation of crystals or the like at their interface. Such precipitation is more likely to occur especially in the case where either one of the solvent or the mobile phase is a high concentration organic solvent and the other is a high concentration buffer. The precipitated substances may clog the inner passage of the needle or cause a so-called “carry-over” in which the previously analyzed components are carried to the next analysis and detected.

The present invention has been developed to solve the aforementioned problems, and the main objective thereof is to provide a liquid sample injection device and liquid sample injection method using a total volume injection method, which can prevent clogging of the inner passage of the needle or carry-over of the components to be analyzed.

### Means for Solving the Problem

The present invention created to solve above problems is a liquid sample injection device for injecting an entire amount of a liquid sample collected from a sample container with a needle into a mobile phase channel of a liquid chromatograph, including:
a) a measuring pump provided in a channel connected to a back end of the needle;
b) a needle-moving mechanism for moving a tip of the needle between an inside of the sample container, a sample injection port provided in the mobile phase channel, and an area where a predetermined fluid which reacts with neither the liquid sample nor the mobile phase is present; and
c) a controller for controlling, before injecting the liquid sample into the sample injection port, the needle-moving mechanism to move the tip of the needle to the aforementioned area, for controlling the measuring pump to suck the predetermined fluid from the tip, for controlling the needle-moving mechanism to insert the tip in the sample container, and for controlling the measuring pump to suck a predetermined amount of the liquid sample in the sample container from the tip.

A liquid sample injection method according to the present invention created to solve above problems is a method for injecting an entire amount of a liquid sample collected with a needle from a sample container into a mobile phase channel of a liquid chromatograph, including steps of, before injecting the liquid sample into a sample injection port provided in the mobile phase channel:
a) moving a tip of the needle to an area where a predetermined fluid which reacts with neither the liquid sample nor the mobile phase is present, and sucking the predetermined fluid from the tip; and
b) inserting, after sucking the predetermined fluid, the tip in the sample container to suck a predetermined amount of the liquid sample in the sample container from the tip.

### EFFECTS OF THE INVENTION

The liquid sample injection device and the liquid sample injection method of the present invention are characterized by the operation of: moving the tip of a needle, before collecting a liquid sample, to the area where a predetermined fluid (for example, air, water, or the like) which reacts with neither the liquid sample nor the mobile phase is present; sucking the predetermined fluid from the tip; and inserting the tip in a sample container to suck a predetermined amount of the liquid sample in the sample container. As a result, a layer of the predetermined fluid is formed between the mobile phase remaining after being sucked in the previous analysis and the newly sucked liquid sample in the needle. Thus, the mobile phase and the liquid sample do not contact each other in the needle. Accordingly, a precipitate due to reaction between the solvent of the liquid sample and the mobile phase can be avoided, resulting in no clogging of the channel with a precipitate nor a carry-over of the previous sample to the next analysis.

### BRIEF DESCRIPTION OF THE DRAWINGS

FIG. 1 is a schematic configuration diagram showing an auto-sampler as an embodiment of the present invention.

FIGS. 2A-2E are explanatory diagrams each showing the position of a needle when the auto-sampler is operated; FIG. 2A shows the needle when sucking air, FIG. 2B shows the needle when sucking the sample, FIG. 2C shows the needle when sucking air once more, FIG. 2D shows the needle when being washed, and FIG. 2E shows the needle when injecting the sample.

FIGS. 3A-3D are explanatory diagrams each showing the tip of the needle upon collecting the sample. FIG. 3A is a sectional view of the needle when air is sucked therein. FIG. 3B is a sectional view of the needle when a liquid sample is sucked therein. FIG. 3C is a sectional view of the needle when air is again sucked therein. FIG. 3D is a sectional view of the needle dipped in a cleaning liquid.

FIG. 4 is a schematic configuration diagram showing the main parts of an auto-sampler capable of introducing a predetermined liquid instead of air.

### BEST MODE FOR CARRYING OUT THE INVENTION

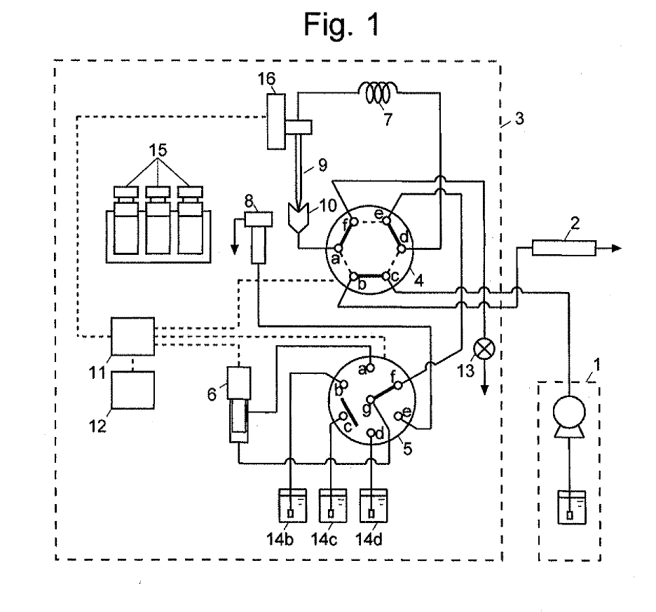

A liquid sample injection device and a liquid sample injection method as an embodiment of the present invention are described with reference to the attached drwaings. An auto-sampler 3, which is a liquid sample injection device of the present embodiment, is used for injecting a liquid sample in a vial 15 to a mobile phase channel of a liquid chromatograph by a total volume injection method (FIG. 1).

The mobile phase channel, in which a high-pressure mobile phase flows, is provided with a high-pressure valve 4. The high-pressure valve 4 is a rotary valve having six ports 4a to 4f for switching flow channels. The high-pressure valve 4 switches the connection of the ports between the state shown by the solid line and the state shown by the dotted line in FIG. 1. A low-pressure valve 5 is provided in another channel provided independently from the mobile phase channel. The low-pressure valve 5 is a rotary valve having seven ports 5a to 5g for switching flow channels. The low-pressure valve 5 can connect the central common port 5g leading to a measuring pump 6 with any one of the surrounding six ports 5a to 5f, or can selectively connect adjacent two ports among the ports 5a to 5f.

The port 4c of the high-pressure valve 4 is connected to a channel communicating with a liquid feed unit 1 of the liquid chromatograph, and the port 4b is connected to a channel communicating with a column 2 of the liquid chromatograph. The port 4d is connected to a channel communicating with a needle 9 through a sample loop 7. The port 4a is connected to a channel communicating with a sample injection port 10. The port 4f is connected to a channel communicating with a drain valve 13. The port 4e is connected to a channel communicating with the port 5f of the low-pressure valve 5.

The port 5e of the low-pressure valve 5 is connected to a channel communicating with a washing port 8 for washing the tip of the needle 9 with a cleaning liquid. The port 5a is connected to a channel communicating with the measuring pump 6. The ports 5b, 5c and 5d are respectively connected to channels each communicating with a cleaning liquid container which stores the cleaning liquid to be supplied to the washing port 8. Here, only one of the ports 5b, 5c and 5d may be linked to the cleaning liquid container. However, as shown in FIG. 1, it is preferable to have separate cleaning liquid containers 14b, 14c and 14d, each storing different cleaning liquids, linked to the port 5b, 5c and 5d, respectively,. This configuration enables changing the cleaning liquid to be supplied to the washing port 8 by appropriately switching the low-pressure valve 5 depending on the kind of the liquid sample or other factors.

A needle-moving mechanism 16 is provided for moving the needle 9 in the horizontal and vertical directions. The needle 9 is moved by the needle-moving mechanism 16 to a position above the vial 15, the washing port 8 or the sample injection port 10, and then vertically moved to be inserted thereinto.

A controller 11 controls the operations of the high-pressure valve 4, the low-pressure valve 5, the measuring pump 6, and the needle-moving mechanism 16 based on a preset program. Examples of the controller include a microcomputer operating with a firmware program for controlling an auto-sampler, and a system controller for a liquid chromatograph or a workstation, which controls not only the auto-sampler but also the liquid chromatograph. An input unit 12, with which an operator can enter various parameters such as a sucking amount of the liquid sample or air (described later), is connected to the controller 11.

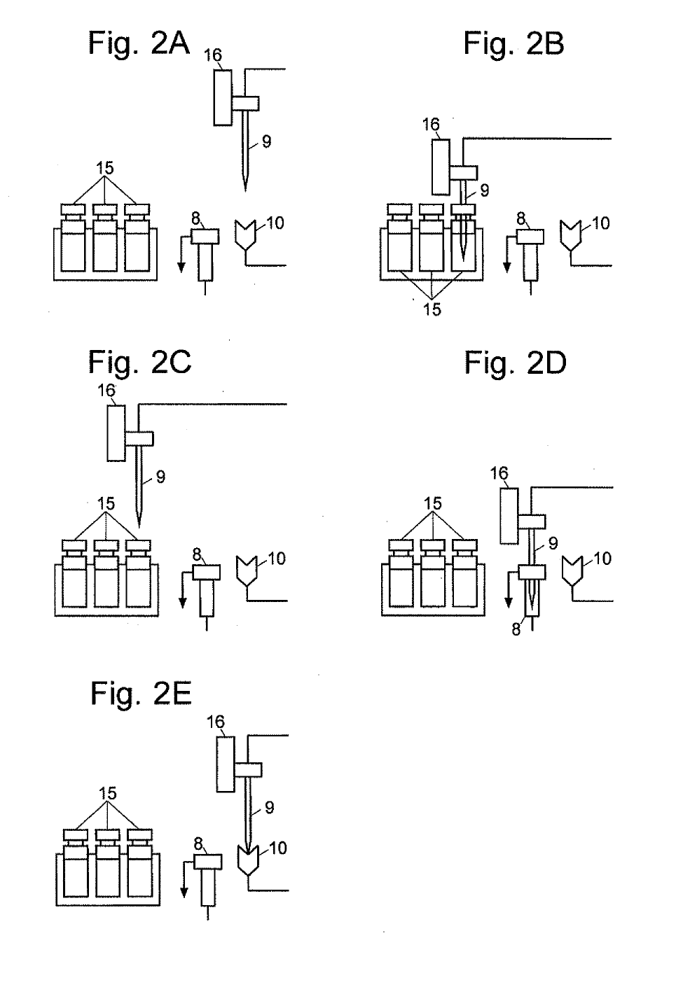

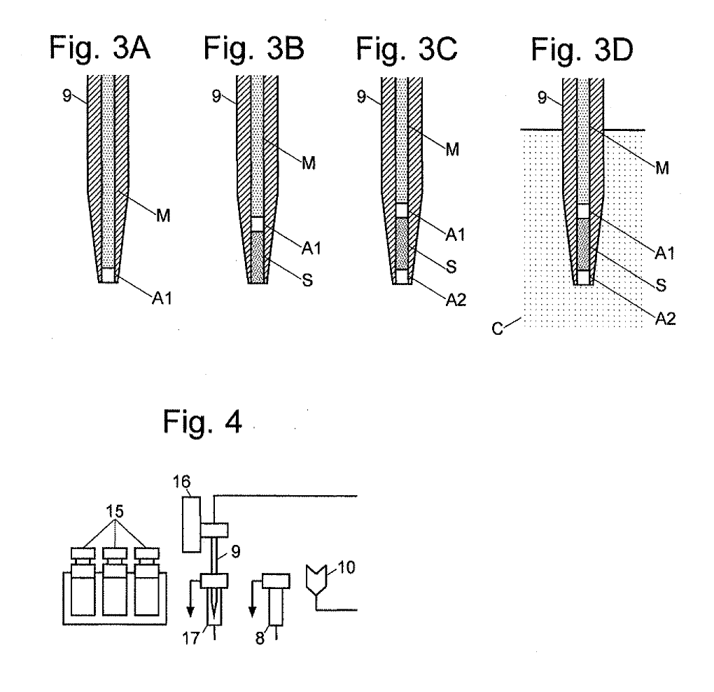

A basic operation sequence of the sample injection in the aforementioned device is as follows. First, the controller 11 operates the high-pressure valve 4 and the low-pressure valve 5 to switch the valves to the state illustrated by the solid lines in FIG. 1. Then, the controller 11 operates the needle-moving mechanism 16 to bring the tip of the needle 9 apart from of the sample injection port 10, the washing port 8 and the vial 15 so that the tip is positioned at an area of air (FIG. 2A). At this time, a mobile phase M sucked in the previous analysis remains in the needle 9, and the inside of the needle 9 is filled to the tip thereof with the mobile phase M. Then, the plunger of the measuring pump 6 is pulled, whereby the mobile phase filled in the channel between the measuring pump 6 and the needle 9 is suctioned, and air is introduced into the tip of the needle 9 to form a first air layer A1 (FIG. 3A). The moving distance of the plunger is set based on an air-sucking amount that has been entered through the input unit 12 by the operator. If a component of the air may react with the liquid sample, the needle 9 may be moves to a space filled with a gas that reacts with neither the liquid sample nor the mobile phase (for example, inert gas) so that such gas is introduced into the needle 9 in place of air.

Next, the controller 11 operates the needle-moving mechanism 16 to insert the tip of the needle 9 into the vial 15 in which the liquid sample to be analyzed is stored (FIG. 2B). Then the plunger of the measuring pump 6a is further pulled to suck a preset amount of the liquid sample S from the tip of the needle 9 (FIG. 3B). The newly sucked liquid sample S will not contact the mobile phase M sucked in the previous analysis and remaining there, because the first air layer A1 exists between the liquid sample S and the mobile phase M. Accordingly, any precipitate by a reaction between the liquid sample S and the mobile phase M can be prevented, whereby clogging of the channel with a precipitate or carry-over of the samples are prevented. Though, in the example shown in FIG. 3B, only a small amount of the liquid sample S is collected in the tip of the needle, a larger amount of the liquid sample S may be collected and charged in the needle 9 and the sample loop 7.

Thereafter, the controller 11 operates the needle-moving mechanism 16 to pull the tip of the needle 9 from the vial 15 to the outside, where air exists (FIG. 2C). Next, the plunger of the measuring pump 6 is pulled so that air is again sucked into the tip of the needle 9 to form a second air layer A2 (FIG. 3C). Then, the controller 11 operates the needle-moving mechanism 16 so that the tip of the needle is dipped in a cleaning liquid C stored in the washing port 8 (FIG. 2D) to wash off the liquid sample adhered to the outer circumferential surface of the tip of the needle 9. In this operation, the liquid sample S and the cleaning liquid C do not contact each other in the washing port 8 owing to the air layer A2 interposed between the liquid sample S in the needle 9 and the cleaning liquid C (FIG. 3D).

After the washing, the controller 11 operates the needle-moving mechanism 16 to insert the needle 9 into the sample injection port 10 (FIG. 2E). The controller 11 then switches the position of the high-pressure valve 4 to the state illustrated with the dotted lines in FIG. 1, whereupon the mobile phase M flows from the liquid feed unit 1 to the sample loop 7 and the needle 9 so as to send the entire amount of the liquid sample S held in the sample loop 7 and the needle 9 to the column 2.

It should be noted that the above embodiment is only one example of the present invention, and any modification or adjustment other than those described thus far can be made within the spirit of the present invention. For example, it is not always necessary to form the second air layer A2 at the downstream side of the liquid sample S (i.e. tip side of the needle) by sucking air once more after the liquid sample S is sucked. However, in the case of a liquid sample with a low viscosity or a high volatility, since the collected liquid sample S tends to leak from the tip of the needle and spread on the outer circumferential surface of the tip of the needle, it is preferable to form the second air layer A2 by again sucking air after sucking the liquid sample S in the same manner as in the aforementioned embodiment, whereby leakage of the liquid sample S is prevented.

The controller 11 may operate the measuring pump 6 to suck air again only in the case where a command of the re-sucking of air is entered in the input unit 12 by the operator. In this case, the operator can optionally decide whether or not to form the second air layer A2 at the downstream of the liquid sample S by only operating the input unit 12 depending on the kinds of the liquid sample or other factors.

Instead of gas as described above, a liquid (for example, water) which reacts with neither the liquid sample S nor the mobile phase M may be used. In this case, as shown in FIG. 4, the tip of the needle 9 is inserted in a liquid introduction port 17 storing the liquid to suck the liquid in place of air. As a result, a layer of the liquid, instead of air, is formed between the liquid sample S and the mobile phase M, preventing contact between the liquid sample S and the mobile phase M.

### EXPLANATION OF NUMERALS

1 . . . Liquid Feed Unit

2 . . . Column

3 . . . Auto-Sampler

4 . . . High-Pressure Valve

5 . . . Low-Pressure Valve

6 . . . Measuring Pump

7 . . . Sample Loop

8 . . . Washing Port

9 . . . Needle

10 . . . Sample Injection Port

11 . . . Controller

12 . . . Input Unit

13 . . . Drain Valve

14b, 14c, 14d . . . Cleaning Liquid Container

15 . . . Vial

16 . . . Needle-Moving Mechanism

17 . . . Liquid Introduction Port

1. A liquid sample injection device for injecting an entire amount of a liquid sample collected from a sample container with a needle into a mobile phase channel of a liquid chromatograph, comprising:
a) a measuring pump provided in a channel connected to a back end of the needle;
b) a needle-moving mechanism for moving a tip of the needle between an inside of the sample container, a sample injection port provided in the mobile phase channel, and an area where a predetermined fluid which reacts with neither the liquid sample nor the mobile phase is present; and
c) a controller for controlling, before injecting the liquid sample into the sample injection port, the needle-moving mechanism to move the tip of the needle to the aforementioned area, for controlling the measuring pump to suck the predetermined fluid from the tip, for controlling the needle-moving mechanism to insert the tip into the sample container, and for controlling the measuring pump to suck a predetermined amount of the liquid sample in the sample container from the tip.

2. The liquid sample injection device according to claim 1,
wherein the predetermined fluid is air.

3. The liquid sample injection device according to claim 1,
wherein the predetermined fluid is water.

4. The liquid sample injection device according to claim 1,
wherein the controller operates, after sucking of the liquid sample, the needle-moving mechanism to move the tip to the aforementioned area, and operates the measuring pump to again suck the predetermined fluid from the tip.

5. The liquid sample injection device according to claim 2,
wherein the controller operates, after sucking of the liquid sample, the needle-moving mechanism to move the tip to the aforementioned area, and operates the measuring pump to again suck the predetermined fluid from the tip.

6. The liquid sample injection device according to claim 3,
wherein the controller operates, after sucking of the liquid sample, the needle-moving mechanism to move the tip to the aforementioned area, and operates the measuring pump to again suck the predetermined fluid from the tip.

7. The liquid sample injection device according to claim 4, further comprising a suction command input unit for allowing an operator to enter a command on whether or not the predetermined fluid should be sucked again,
wherein the controller operates the measuring pump to again suck the aforementioned fluid only in the case where a command for again sucking the fluid has been entered through the suction command input unit.

8. The liquid sample injection device according to claim 5, further comprising a suction command input unit for allowing an operator to enter a command on whether or not the predetermined fluid should be sucked again,
wherein the controller operates the measuring pump to again suck the aforementioned fluid only in the case where a command for again sucking the fluid has been entered through the suction command input unit.

9. The liquid sample injection device according to claim 6, further comprising a suction command input unit for allowing an operator to enter a command on whether or not the predetermined fluid should be sucked again,
wherein the controller operates the measuring pump to again suck the aforementioned fluid only in the case where a command for again sucking the fluid has been entered through the suction command input unit.

10. The liquid sample injection device according to claim 1, further comprising a sucking amount input unit for allowing an operator to enter an amount of the predetermined fluid to be sucked,
wherein the controller operates, upon sucking the predetermined fluid, the measuring pump to suck the predetermined fluid in an amount entered through the sucking amount input unit.

11. The liquid sample injection device according to claim 2, further comprising a sucking amount input unit for allowing an operator to enter an amount of the predetermined fluid to be sucked,
wherein the controller operates, upon sucking the predetermined fluid, the measuring pump to suck the predetermined fluid in an amount entered through the sucking amount input unit.

12. The liquid sample injection device according to claim 3, further comprising a sucking amount input unit for allowing an operator to enter an amount of the predetermined fluid to be sucked,
wherein the controller operates, upon sucking the predetermined fluid, the measuring pump to suck the predetermined fluid in an amount entered through the sucking amount input unit.

13. The liquid sample injection device according to claim 4, further comprising a sucking amount input unit for allowing an operator to enter an amount of the predetermined fluid to be sucked,
wherein the controller operates, upon sucking the predetermined fluid, the measuring pump to suck the predetermined fluid in an amount entered through the sucking amount input unit.

14. The liquid sample injection device according to claim 5, further comprising a sucking amount input unit for allowing an operator to enter an amount of the predetermined fluid to be sucked,
wherein the controller operates, upon sucking the predetermined fluid, the measuring pump to suck the predetermined fluid in an amount entered through the sucking amount input unit.

15. The liquid sample injection device according to claim 6, further comprising a sucking amount input unit for allowing an operator to enter an amount of the predetermined fluid to be sucked,
wherein the controller operates, upon sucking the predetermined fluid, the measuring pump to suck the predetermined fluid in an amount entered through the sucking amount input unit.

16. The liquid sample injection device according to claim 7, further comprising a sucking amount input unit for allowing an operator to enter an amount of the predetermined fluid to be sucked,
wherein the controller operates, upon sucking the predetermined fluid, the measuring pump to suck the predetermined fluid in an amount entered through the sucking amount input unit.

17. The liquid sample injection device according to claim 8, further comprising a sucking amount input unit for allowing an operator to enter an amount of the predetermined fluid to be sucked,
wherein the controller operates, upon sucking the predetermined fluid, the measuring pump to suck the predetermined fluid in an amount entered through the sucking amount input unit.

18. The liquid sample injection device according to claim 9, further comprising a sucking amount input unit for allowing an operator to enter an amount of the predetermined fluid to be sucked,
wherein the controller operates, upon sucking the predetermined fluid, the measuring pump to suck the predetermined fluid in an amount entered through the sucking amount input unit.

19. A liquid sample injection method for injecting an entire amount of the liquid sample collected with a needle from a sample container into a mobile phase channel of a liquid chromatography, comprising steps of, before injecting the liquid sample into a sample injection port provided in the mobile phase channel:
a) moving a tip of the needle to an area where a predetermined fluid which reacts with neither the liquid sample nor the mobile phase is present, and sucking the predetermined fluid from the tip; and
b) inserting, after sucking the predetermined fluid, the tip in the sample container to suck a predetermined amount of the liquid sample in the sample container from the tip.
